(19) United States
(12) Patent Application Publication
(10) Pub. No.: US 2025/0253690 A1
(43) Pub. Date: Aug. 7, 2025

(54) CHARGING CASE

(71) Applicant: Apple Inc., Cupertino, CA (US)

(72) Inventors: Josiah C. Frye, Bothell, WA (US); Ibuki Kamei, Santa Clara, CA (US); Varun K. Sanghvi, San Francisco, CA (US); Mary S. Poletti, Woodside, CA (US)

(21) Appl. No.: 18/953,515

(22) Filed: Nov. 20, 2024

Related U.S. Application Data
(60) Provisional application No. 63/549,202, filed on Feb. 2, 2024.

(51) Int. Cl. H02J 7/00; G06F 1/16

(52) U.S. Cl. CPC H02J 7/0044; G06F 1/1632

(57) ABSTRACT

An electronic device charging case includes a body defining a cavity and an opening, the cavity having a terminal end defined by the body, the terminal end opposite the opening, a charging block including a protrusion disposed within the cavity between the terminal end and the opening, the charging block including a first conductive contact and a second conductive contact, and a power supply electrically coupled to the first conductive contact and the second conductive contact.

### CROSS-REFERENCE TO RELATED APPLICATION

This application claims the benefit of U.S. Provisional Patent Application No. 63/549,202, filed 2 Feb. 2024, and entitled “CHARGING CASE,” the entire disclosure of which is hereby incorporated by reference.

### FIELD

The examples described in the present disclosure relate generally to electronic device charging. More particularly, the examples described in the present disclosure relate to charging cases for wearable electronic devices.

### BACKGROUND

Recent advances in portable computing have enabled wearable devices, including wearable devices such as smart watches, earphones, and display devices providing augmented reality and virtual reality (AR/VR) to users. AR/VR devices and other wearable devices can include batteries so they can be portably powered and used independent from a corded power source. In some examples, cases meant to hold and protect the portable device can include electrical connections to batteries in the case or corded connections such that placing the device in the case for storage also charges the device. However, depending on the type of portable device, it is difficult to ensure the proper electrical connection is made between the device and the charging contacts or charging source within the case. This is true, for example, where the geometry of the device is complicated or customized, or where the position of the device within the case can vary. In addition, the electrical contacts in the case can be unsightly and prone to damage when exposed.

### SUMMARY

In at least one example of the present disclosure, an electronic device charging case includes a body defining a cavity and an opening, the cavity having a terminal end defined by the body, the terminal end opposite the opening, a charging block including a protrusion disposed within the cavity between the terminal end and the opening, the charging block including a first conductive contact and a second conductive contact, and a power supply electrically coupled to the first conductive contact and the second conductive contact.

In one example, the first conductive contact and the second conductive contact are hidden from view through the opening by the protrusion. In one example, the protrusion defines a surface extending within the cavity, the first conductive contact defines the surface, and the second conductive contact defines the surface. In one example, the charging block is translatable relative to the body and a translation of the charging block exposes the first conductive contact and the second conductive contact. In one example, the charging block is rotatable relative to the body and a rotation of the charging block exposes the first conductive contact and the second conductive contact. In one example, the power supply includes a power port. In one example, the power supply includes a battery. In one example, the charging block is shaped to physically mate with a nasal bridge feature of smart glasses.

In at least one example of the present disclosure, an electronic charging device includes a body defining a cavity and an opening, the body including a lower terminal surface defining the cavity, a charging protrusion extending from the body within the cavity between the lower internal surface and the opening, the charging protrusion including a conductive contact, the charging protrusion positioned to obscure a line of sight between the opening and the conductive contact, and a power supply electrically coupled to the conductive contact.

In one example, the charging protrusion defines a datum surface extending within the cavity and the conductive contact is recessed relative to the datum surface. In one example, the datum surface is positioned to prevent an electronic device disposed in the cavity from moving beyond the charging protrusion. In one example, the charging protrusion is movable within the cavity. In one example, when the charging protrusion is rotated relative to the body, a line of sight is unobstructed by the charging protrusion. In one example, when the charging protrusion is translated relative to the lower internal surface, the line of sight is unobstructed by the charging protrusion.

In at least one example of the present disclosure, a charging case can include a body defining a cavity and an opening, the body including a lower surface defining the cavity, a charging protrusion movably secured to the body within the cavity between the lower surface and the opening, the charging protrusion including a conductive contact, and a power supply electrically coupled to the conductive contact. In such an example, when the charging protrusion is moved relative to the body by an external force, the conductive contact is exposed to make electrical contact with a device disposed in the cavity, and when the charging protrusion is at rest without the external force acting on the charging protrusion, the charging protrusion is positioned to obscure a line of sight between the opening and the conductive contact.

In one example, the charging protrusion is rotatable relative to the body. In one example, the charging protrusion is translatable relative to the lower surface. In one example, the charging protrusion is shaped to be keyed with a nasal bridge of an electronic glasses device. In one example, the conductive contact is a first conductive contact and the charging protrusion further includes a second conductive contact. In one example, the line of sight is a first line of sight, when the charging protrusion is moved relative to the body by the external force, the second conductive contact is exposed to make electrical contact with the device, and when the charging protrusion is at rest without the external force acting on the charging protrusion, the charging protrusion is positioned to obscure a second line of sight between the opening and the second conductive contact.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example of a charging case and an electronic device configured to be stored and charged in the charging case;

FIG. 2 shows a cross-sectional view of an example of a charging case;

FIG. 3 shows a cross-sectional view of an example of a charging case;

FIG. 4A shows a cross-sectional view of an example of a charging case;

FIG. 4B shows another cross-sectional view of the example of the charging case shown in FIG. 4A;

FIG. 5A shows a cross-sectional view of an example of a charging case;

FIG. 5B shows another cross-sectional view of the example of the charging case shown in FIG. 5A;

FIG. 6A shows a cross-sectional view of an example of a charging case; and

FIG. 6B shows another cross-sectional view of the example of the charging case shown in FIG. 6A.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to electronic device charging. More particularly, the examples described herein relate to charging cases or charging stands for wearable electronic devices. The charging cases and/or stands described herein can include electrically conductive contacts coupled to a power supply. The contacts can be positioned such that when an electronic device is placed in the case, the contacts of the case make electrical contact with corresponding charging contacts of the device to charge the device. The cases described herein can include a block or a protrusion within the cavity, for example between an opening in which the device can be inserted and a lower surface or end of the cavity. The block can be configured to interfere with and contact the device when inserted. This block can be a charging block including the conductive contacts of the case for charging the device.

In at least one example, when the case is empty, the conductive contacts of the charging block can be hidden from view to improve the aesthetics of the charging case. When a device is placed into the case for charging, the conductive contacts can be exposed for contact with the device and charging functionality. In at least one example, the charging block is movably secured to the body of the case within the cavity. When an electronic device is placed in the cavity, the device makes contact with the charging block and the charging block moves. In one example, the charging block can translate relative to the body of the case. In another example, the charging block can rotate relative to the body of the case. Other types of movement are also considered. When the charging block is moved, for example by the placement of the electronic device in the cavity, the hidden conductive contacts can be exposed and positioned to electrically couple with charging contacts of the device. Once the device is removed, for instance after charging or for use outside the case, the charging block can return to an original position where the conductive contacts are hidden from view.

In addition, the charging block can be positioned and shaped to guide the placement of the electronic device in the cavity for adequate and consistent contact between the conductive contacts of the charging block in the case and the charging contacts of the electronic device. In one example, the electronic device can include an augmented reality or virtual reality (AR/VR) device, for example goggles, headsets, smart glasses, and so forth, which can include a nose bridge for resting on the nose of a user when worn. In some examples, the charging block in the case can include surface geometries complimentary to, and keyed with, the nose bridge of the device. In this way, even if the user places the device off-center in the case or otherwise ill positioned, the charging block can guide the nose bridge of the device onto the charging block and into contact with the conductive contacts in the case.

Accordingly, the charging cases disclosed herein are configured to ensure a proper electrical connection is made between the device and the charging contacts or charging source within the case, even when the geometry of the device is complicated or customized, for instance eyewear or other wearable devices, or where the position of the device within the case can vary. In addition, the conductive electrical contacts in the case can be hidden from view from the user to improve aesthetics and protect the contacts from damage.

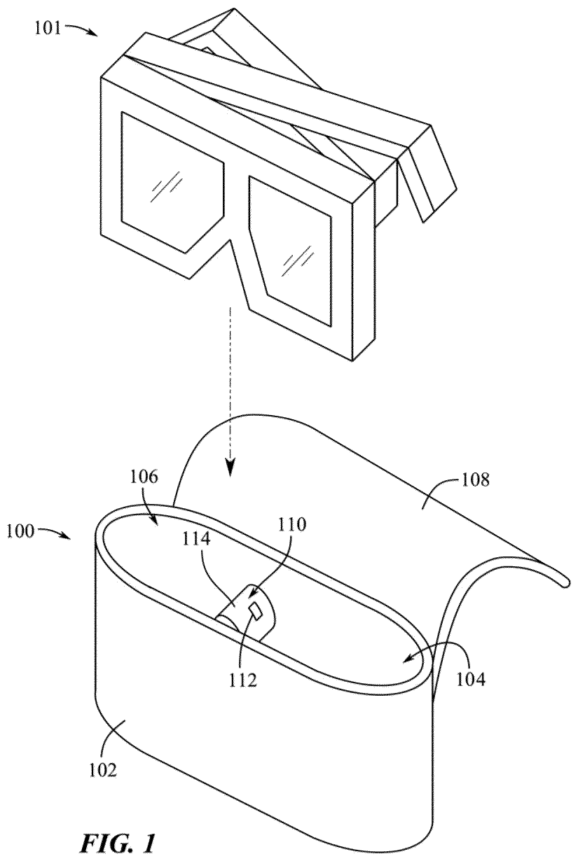

These and other embodiments are discussed below with reference to FIGS. 1-6B. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

While the present exemplary charging systems are described in the context of a charging case, the charging systems and the teaching associated therewith detailed herein can also be applied to any number of charging devices for AR/VR systems including, but in no way limited to desktop or countertop charging pedestals, automotive charging systems, and the like. Furthermore, the described charging case is not necessarily fully enclosed or otherwise fully or even partially enclosing the charging device or any AR/VR system attached thereto.

FIG. 1 shows an example of an electronic device charging case 100. The charging case 100 can be a charging device configured to receive and store an electronic device 101, which can include a wearable electronic device. The electronic device 101 shown in the example of FIG. 1 includes wearable smart glasses for providing AR/VR experiences to user's donning the device. Other wearable devices can include AR/VR goggles, head-mounted devices, and the like. Thus, in at least one example, the charging case 100 can include a body 102 defining an internal volume or cavity 104 accessible for insertion of the electronic device 101 through an opening 106. This opening 106 can be referred to as an upper opening or main opening. In at least one example, the charging case 100 can also include a lid 108 for selectively covering the opening 106, either to reveal the opening 106 or to cover the opening 106.

In at least one example, the charging case 100 can include a charging block 110, which can include a protrusion, for example a charging protrusion, extending within the cavity 104 between a lower or bottom portion of the cavity and the opening 106. In at least one example, the charging block 110 can include a datum surface 114 for contacting the electronic device 101 when placed in the cavity 104 and configured to act as a datum or obstruction for positioning the device 101 against the protrusion of the charging block 110 in the cavity 104. The datum surface 114 can extend within the cavity 104 to prevent the device 101 from moving beyond the charging block 110 in the cavity 104 and positioning the device 101 appropriately within the cavity 104 to make electrical contact with a conductive contact 112 of the charging block 110.

In at least one example, the charging block 110 can include the conductive contact 112, which can be electrically coupled to a power supply within or external to the charging case 100 (not shown in FIG. 1). In at least one example, the conductive contact 112 of the charging block 110 can be positioned to make electrical contact with one or more charging contacts (not shown in FIG. 1) of the device 101 when the device 101 is inserted into the cavity 104 for charging and storage. The electrical power from the power supply can flow through the conductive contact 112 to the device 101 to charge one or more batteries of the device 101 for further use.

Any of the features, components, and/or parts, of the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

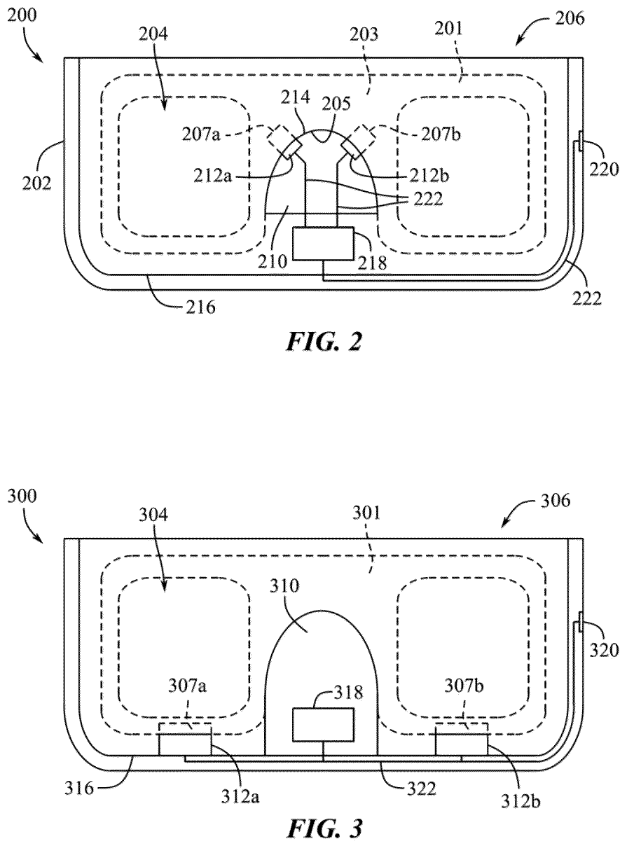

FIG. 2 shows a cross-sectional view of another example of an electronic device charging case 200, including a body 202 defining a cavity 204 and an opening 206, and a charging block 210. The cavity 204 can include or define a terminal end 216 defined by the body 202, with the terminal end 216 being opposite the opening 206. In at least one example, the charging case 200 can include a power supply, which can include a battery 218, a power port 220 for plugging into an external power supply, or both. In the illustrated example, the battery 218 is electrically coupled to the power port 220 via one or more circuitry components 222, which can include wires, cables, and so forth. In at least one example, the port 220 can be configured to receive or be coupled with an external power source, such as a wall outlet or other battery, to charge the battery 218 and/or charge the device 201 when connected to a power source.

In at least one example, the charging case 200 is configured to receive and charge a head-mountable electronic device 201, which can include smart glasses as shown in FIG. 2. The device 201 can include a nasal bridge 203 defining a nasal bridge surface 205 for resting on the nose of a user when the device 201 is donned. In at least one example, the charging block 210 can be shaped to physically mate with the nasal bridge surface 205 of the device 201 when the device 201 is disposed in the cavity 204. In the example shown in FIG. 1, the charging block 210 can include or define a keyed surface 214 extending in the cavity 204, which is shaped and dimensioned to key with the nasal bridge surface 205 of the device 201. The keyed surface 214 shown in FIG. 2 can be the same or similar to the datum surface 114 shown in FIG. 1. In this way, the keyed surface 214 is positioned and configured to guide the device 201 into a correct position for charging when a user places the device 201 into the cavity 204 of the charging case 200.

For example, when a user places the device 201 into the cavity 204 slightly off-center relative to the charging block 210, for example with the nasal bridge surface 305 misaligned with the keyed surface 214, the keyed surface 214 can contact the nasal bridge surface 205 and guide the device 201 into the correct position to rest or contact on the charging block 210. This correct position can include a position of the device 201 that results in an electrical connection between the charging contacts 207a-b of the device 201 and the conductive contacts 212a-b of the charging block 210. In this way, the charging block 210 reduces the required accuracy of placement by the user and the system self-aligns for initiating charging of a battery electrically coupled to the charging contacts 207a-b of the device 201.

In at least one example, the charging block 210 includes a protrusion disposed within the cavity 204 between the terminal end 216 and the opening 206. The terminal end 216 of the cavity 204 can be defined by a lower internal surface or portion of the body 202. In at least one example, the charging block 210 can include a first conductive contact 212a and a second conductive contact 212b. The charging case 200 can include a power supply, either a battery 218 and/or a power port 220, electrically coupled to the first conductive contact 212a and the second conductive contact 212b via one or more circuitry components 222.

In at least one example, the protrusion of the charging block 210 defines a surface 214 extending within the cavity 204. This surface 214 can be a datum surface configured to mate with the nasal bridge surface 205, as noted above. In at least one example, the first and/or second conductive contacts 212a-b can be flush with or extend above the surface 214. In examples where the first and/or second conductive contacts 212a-b are flush with the surface 214, the first and/or second conductive contacts 212a-b can define the surface 214. In one or more other examples, the first and/or second conductive contacts 212a-b can be recessed from or below the surface 214 such that the charging block 210 hides the contacts 212a-b from view. In at least one example, the first and/or second conductive contacts 212a-b are positioned to correspond to respective first and second charging contacts 207a-b of the device 201 when the device is disposed in the cavity 204. In at least one example, the conductive contacts 212a-b of the charging block 210 include electrically conductive material, for example copper or other metals, conductive ceramics and glass, and so forth. In at least one example, the battery 218 of the charging case 200 can be disposed within the body 202, within the cavity 204, or within the charging block 210.

Any of the features, components, and/or parts, of the arrangements and configurations thereof shown in FIG. 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2.

FIG. 3 shows a cross-sectional view of another example of a charging case 300 including a body 302 defining an internal volume or cavity 304 with a smart glasses device 301 placed therein (shown in dotted lines). The charging case 300 can include a battery 318 and/or a port 320 electrically coupled via circuitry components 322. In at least one example, the charging case 300 can include a charging block 310 including a protrusion extending between the lower surface 316 of the body 302 defining the cavity 304 and the opening 306 of the cavity 304 opposite the lower surface 316. In at least one example, the charging block 310 can extend from the lower surface 316 as shown in FIG. 3.

In at least one example, the charging case 300 can include first and second conductive contacts 312a-b disposed at or near the lower surface 316 within the cavity 304. In at least one example, the first and second conductive contacts 312a-b can be electrically coupled to the power port 320 and the battery 318 via one or more circuitry components 322. In at least one example, the battery 318 can be disposed within the charging block 310. In at least one example, the charging block 310 can be shaped to correspond to a shape of a portion of the device 301 such that the device 301 settles on the charging block 310.

In at least one example, the first and second conductive contacts 312a-b are disposed laterally on either side of the charging block 310 in order to correspond in position to respective first and second charging contacts 307a-b of the smart glasses device 301, which can be positioned on lower portions of either eye-piece of the device 301 as shown. Other examples of charging cases and devices configured to be charged and stored therein can include different positions of the conductive contacts 312a-b and charging contacts 307a-b so long as they are positioned such that when the device 301 is placed in the charging case 300, the conductive contacts 312a-b and charging contacts 307a-b make electrical contact with one another to couple power from the battery 318 to the device 301, including to a battery in the device 301. In any example shown in the figures and described herein, the charging contacts 307a-b can be electrically coupled to one or more batteries of the device 301 such that the one or more batteries of the device 301 are electrically re-charged upon insertion of the device 301 into the cavity 304 of the charging case 300.

Any of the features, components, and/or parts, of the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

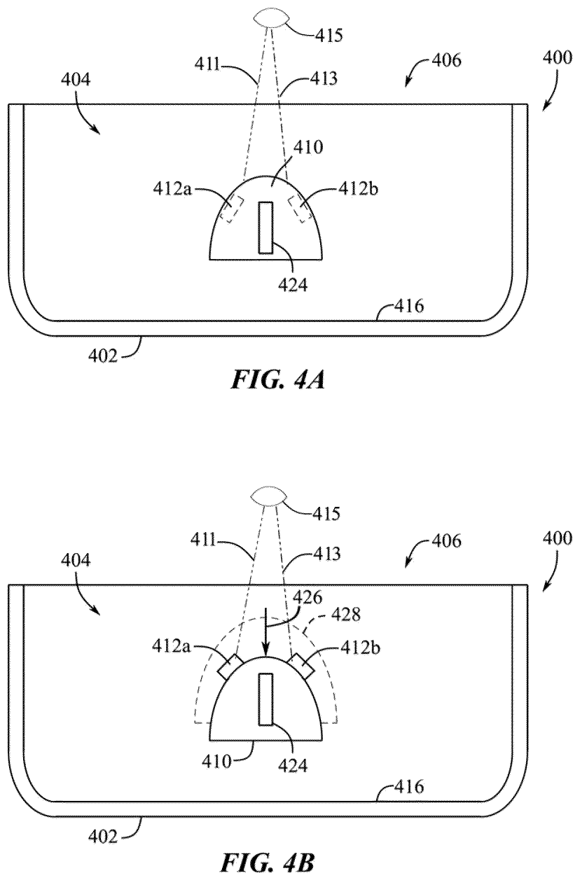

FIG. 4A shows a cross-sectional view of another example of a charging case 400 including a body 402 defining an internal cavity 404 and an opening 406 to the cavity 404 opposite the lower internal surface 416 of the body 402 defining the cavity. The charging case 400 also includes a charging block 410 or charging protrusion disposed within the cavity 404 and extending within the cavity 404. In at least one example, the charging block 410 is movably secured to the body 402 within the cavity 404 between the opening 406 and the lower internal surface 416. In at least one example, the charging protrusion or block 410 includes a first conductive contact 412a and a second conductive contact 412b.

In the illustrated example of FIG. 4A, the conductive contacts 412a-b are hidden from view through the opening 406 by the protrusion of the charging block 410. In at least one example, in the position of the charging block 410 shown in FIG. 4A, the first and second conductive contacts 412a-b can be recessed relative to a surface of the charging block 410 (e.g., similar to the datum surface 214 shown in FIG. 2) such that the contacts 412a-b are hidden from view.

In at least one example, the movably secured charging block 410 is translatable within the cavity 404 between the lower internal surface 416 and the opening 406 via a translation mechanism 424. The charging block 410 can thus be translatable relative to the lower internal surface 416. In the position of the charging block 410 shown in FIG. 4A, the charging block 410 obscures a first line of sight 411 between the opening 406 and the first conductive contact 412a and obscures a second line of sight 413 between the opening 406 and the second conductive contact 412b. The first and second lines of sight 411, 413 can be between an eye 415 of the user and the respective contacts 412a-b through the opening 406 when no device is place in the cavity 404 as shown in FIG. 4A.

In at least one example, as shown in FIG. 4B, when an external force represented by arrow 426 acts on the charging block 410, the charging block 410 is configured to move downward relative to the lower internal surface 416 from a first position 428 to the position of the charging block 410 shown in FIG. 4B. In at least one example, when the charging block 410 is translated as shown, the first and second conductive contacts 412a-b can remain in place or move to be exposed beyond or outside of the charging block 410. Once unobstructed and exposed, the conductive contacts 412a-b can be contacted for charging devices in the charging case 400 as described herein. In at least one example, the external force represented by arrow 426 can be from an electronic device being place into the cavity 404 and against the charging block 410. When the device is removed, the force at arrow 426 is no longer present such that the charging block 410, which can be spring-loaded or otherwise biased toward the first position 428, can return to the first position 428 as represented in FIG. 4A to visually hide the contacts 412a-b.

In this way, the charging case 400 remains visually appealing by hiding the contacts 412a-b when no device is present in the cavity 404 and the contacts 412a-b are accessible and exposed for charging purposes when a device is placed in the cavity 404. In such an example, when the charging block 410 is translated as shown in FIG. 4B, the first and second lines of sight 411, 413 between the eye 415 and the contacts 412a-b through the opening 406 is unobscured by the charging block 410 or protrusion.

Any of the features, components, and/or parts, of the arrangements and configurations thereof shown in FIGS. 4A-4B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4A-4B.

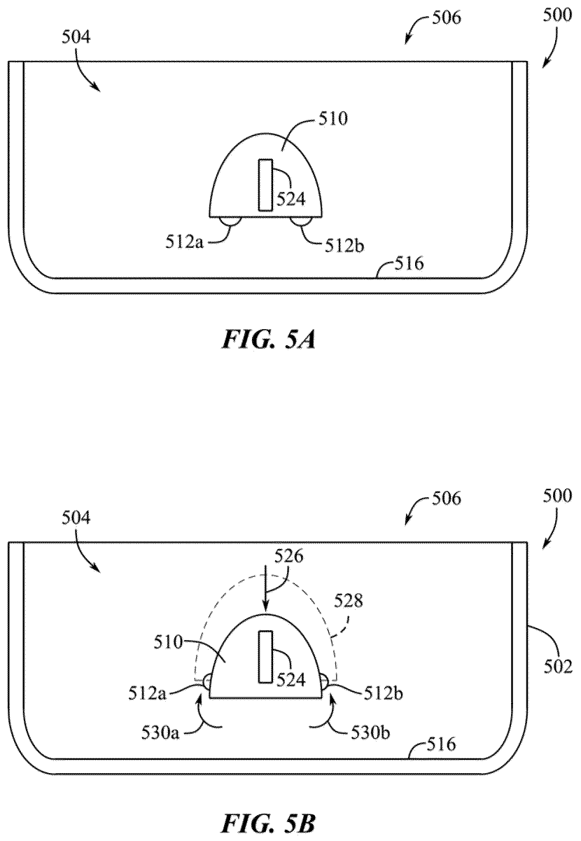

FIG. 5A shows a cross-sectional view of another example of a charging case 500 including a body 502 defining an internal volume or cavity 504 with a terminal lower end or surface 516 opposite an opening 506 providing access to the cavity 504. The charging case 500 includes a charging block 510 movably coupled to the case 500 via a translation mechanism 524 or other movement mechanism. As shown in FIG. 5A, when the charging block 510 is in a resting position, the first and second conductive contacts 512a-b are hidden from view through the opening 506 by the charging block 510. As shown in FIG. 5B, when an external force at arrow 526, for example a downward force from a device being pushed against the charging block 510 when inserted into the cavity 504, the charging block 510 can translate downward from the first position 528 as shown in FIG. 5A to the second position of the charging block 510 shown in FIG. 5B. Correspondingly, with the movement of the charging block 510, the conductive contacts 512a-b can be moved outward and upward, as indicated by respective arrows 530a and 530b, to be unobstructed and exposed, both physically and visually, and to make contact with respective charging contacts of the device to be charged in the case 500.

Any of the features, components, and/or parts, of the arrangements and configurations thereof shown in FIGS. 5A-5B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 5A-5B.

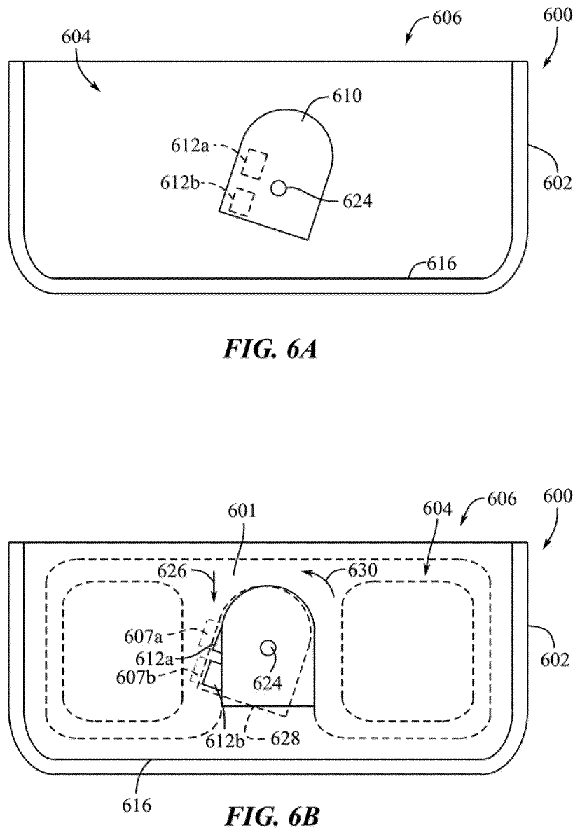

FIG. 6A shows a cross-sectional view of another example of a charging case 600 including a body 602 defining an internal volume or cavity 604 with a terminal lower end or surface 616 opposite an opening 606 providing access to the cavity 604. The charging case 600 includes a charging block 610 rotatably secured to the case 600 via a rotation or pivot mechanism 624 or other movement mechanism. As shown in FIG. 6A, when the charging block 610 is in a resting position, the first and second conductive contacts 612a-b are hidden from view through the opening 606 by the charging block 610. As shown in FIG. 6B, when an external force at arrow 626, for example a downward force from a device 601 being pushed against the charging block 610 when inserted into the cavity 604, the charging block 610 can rotate as shown by arrow 630 from the first position 628 as shown in FIG. 6A to the second position of the charging block 610 shown in FIG. 6B. Correspondingly, with the movement of the charging block 610, the conductive contacts 612a-b can be moved outward and upward to be exposed, both physically and visually, to make contact with respective charging contacts 607a-b of the device to be charged in the cavity 604 of the case 600.

Any of the features, components, and/or parts, of the arrangements and configurations thereof shown in FIGS. 6A-6B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 6A-6B.

Other examples of charging cases can include charging blocks or protrusions having various geometries, surfaces, conductive contacts, and so forth, which expose the contacts based on movements other than translational and rotational movements shown in the figures. Other movements of charging blocks to hide and expose conductive contacts can include translation in-and-out of the viewing plane of FIGS. 2-6B, rotations about other axes, irregular movement paths, and so forth. In addition, the position, shape, and size of the charging blocks shown and described herein can vary in other examples to accommodate other positions, sizes, and shapes of electronic devices being placed within the case.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic device charging case, comprising:
a body defining a cavity and an opening, the cavity having a terminal end defined by the body, the terminal end opposite the opening;
a charging block including a protrusion disposed within the cavity between the terminal end and the opening, the charging block including:
a first conductive contact;
a second conductive contact; and
a power supply electrically coupled to the first conductive contact and the second conductive contact.

2. The electronic device charging case of claim 1, wherein the first conductive contact and the second conductive contact are hidden from view through the opening by the protrusion.

3. The electronic device charging case of claim 1, wherein:
the protrusion defines a surface extending within the cavity;
the first conductive contact defines the surface; and
the second conductive contact defines the surface.

4. The electronic device charging case of claim 1, wherein:
the charging block is translatable relative to the body; and
a translation of the charging block exposes the first conductive contact and the second conductive contact.

5. The electronic device charging case of claim 1, wherein:
the charging block is rotatable relative to the body; and
a rotation of the charging block exposes the first conductive contact and the second conductive contact.

6. The electronic device charging case of claim 1, wherein the power supply includes a power port.

7. The electronic device charging case of claim 1, wherein the power supply includes a battery.

8. The electronic device charging case of claim 1, wherein the charging block is shaped to physically mate with a nasal bridge feature of smart glasses.

9. An electronic charging device, comprising:
a body defining a cavity and an opening, the body including a lower internal surface defining the cavity;
a charging protrusion extending from the body within the cavity between the lower internal surface and the opening, the charging protrusion including a conductive contact, the charging protrusion positioned to obscure a line of sight between the opening and the conductive contact; and
a power supply electrically coupled to the conductive contact.

10. The electronic charging device of claim 9, wherein:
the charging protrusion defines a datum surface extending within the cavity; and
the conductive contact is recessed relative to the datum surface.

11. The electronic charging device of claim 10, wherein the datum surface is positioned to prevent an electronic device disposed in the cavity from moving beyond the charging protrusion.

12. The electronic charging device of claim 10, wherein the charging protrusion is movable within the cavity.

13. The electronic charging device of claim 12, wherein when the charging protrusion is rotated relative to the body, the line of sight is unobstructed by the charging protrusion.

14. The electronic charging device of claim 12, wherein when the charging protrusion is translated relative to the lower internal surface, the line of sight is unobstructed by the charging protrusion.

15. A charging case, comprising:
a body;
a charging protrusion movably secured to the body, the charging protrusion including a conductive contact; and
a power supply electrically coupled to the conductive contact;
wherein:
when the charging protrusion is moved relative to the body by an external force, the conductive contact is exposed to make electrical contact with a device disposed in the cavity; and
when the charging protrusion is at rest without the external force acting on the charging protrusion, the charging protrusion is positioned to obscure a line of sight directed to the conductive contact.

16. The charging case of claim 15, wherein the charging protrusion is rotatable relative to the body.

17. The charging case of claim 15, wherein the charging protrusion is translatable relative to the body.

18. The charging case of claim 15, wherein the charging protrusion is shaped to be keyed with a nasal bridge of an electronic glasses device.

19. The charging case of claim 15, wherein:
the conductive contact is a first conductive contact; and
the charging protrusion further includes a second conductive contact.

20. The charging case of claim 19, wherein:
the line of sight is a first line of sight;
when the charging protrusion is moved relative to the body by the external force, the second conductive contact is exposed to make electrical contact with the device; and
when the charging protrusion is at rest without the external force acting on the charging protrusion, the charging protrusion is positioned to obscure a second line of sight directed to the second conductive contact.
